(19) United States
(12) Patent Application Publication
(10) Pub. No.: US 2025/0185839 A1
(43) Pub. Date: Jun. 12, 2025

(54) BREW DEVICE

(71) Applicant: Trail Ridge Tech LLC, Highlands Ranch, CO (US)

(72) Inventors: LeRoy D. Jutte, Highlands Ranch, CO (US); Ruth L. Jutte, Highlands Ranch, CO (US); Brandon D. Jutte, Highlands Ranch, CO (US)

(21) Appl. No.: 18/957,850

(22) Filed: Nov. 24, 2024

Related U.S. Application Data
(63) Continuation-in-part of application No. 29/974,679, filed on Nov. 24, 2024.
(60) Provisional application No. 63/608,311, filed on Dec. 11, 2023.

(51) Int. Cl. A47J 31/44; A47J 31/46

(52) U.S. Cl. CPC A47J 31/4403; A47J 31/468

(57) ABSTRACT

A portable brew device includes a pump to draw hot water from an external source. The brew device injects the hot water into a medium to be brewed and dispenses the brewed liquid. The brew device includes a support that may be stowed within a housing of the brew device and deployed to elevate the brew device over a surface, where a vessel can collect the brewed liquid dispensed by the brew device. Brewing systems and brewing methods are also disclosed.

### CROSS-REFERENCE TO RELATED APPLICATION

This application claims the benefit of priority to the Dec. 11, 2023 filing date of U.S. Provisional Patent Application No. 63/608,311, titled MULTI-SERVING PORTABLE BEVERAGE DISPENSER, the entire disclosure of which is hereby incorporated herein.

This application is a continuation-in-part of U.S. Design patent application Ser. No. 29/974,679, filed on Nov. 24, 2024 and titled PORTABLE BREWING DEVICE, the entire disclosure of which is hereby incorporated herein.

### TECHNICAL FIELD

This disclosure relates generally to portable devices that brew beverages. More specifically, the disclosure relates to portable devices for brewing a plurality of servings of a beverage. This disclosure also relates to methods for brewing a plurality of servings of a beverage.

### RELATED ART

The use of single serve coffee or beverage brewing systems is known. Keurig introduced systems that brew single servings of coffee, other hot beverages, or other media stored in single-use filter pods. Keurig's brewing systems are very popular for use in homes and offices. Although very useful in these environments, the use of single serve brewing systems is typically limited to locations where mains power is available. Thus, the use of such systems is typically confined to the home or office; they cannot be used for many outdoor activities like camping, climbing, picnics, concerts, and tailgating.

French press and AeroPress systems may be used portably. In French press and AeroPress systems, coffee grounds are placed in a cylindrical vessel, hot water is added to the vessel, and. after a certain amount of time has passed to enable the coffee to brew, a filter disk mechanism is pressed through the slurry, which pushes the grounds to the bottom of the vessel, leaving filtered coffee above the filter. Other systems utilize small vessels that are filled with hot water, which is pumped through the media to be brewed, again producing a limited volume of brewed media.

Modern portable brewing systems include vessels that hold a volume of water that may be heated under battery power. Typically, existing portable brewing systems may only be used to brew small volumes (e.g., one to three small servings), such as a few servings of espresso or a few small servings of tea. Once the small volume of water has been heated and brewing is complete, the battery must be recharged (e.g., from a power accessory of a vehicle, from mains power, etc.), placing the portable brewing system out of commission for a while before it can be used for further brewing. The power required to heat larger volumes of water would necessitate a much larger battery, which would reduce the portability of the brewing system.

### SUMMARY

In one aspect, a brew device is disclosed. A brew device according to this disclosure can be used to brew a hot liquid, such as a beverage, broth, vegetable stock, or the like. The brew device may include a pump, a battery, a holder, a needle, and a dispenser. The pump of the brew device may draw hot water from an external source through a tube, which may be referred to as an “intake tube.” The intake tube may include a free end positionable within a volume of hot water in the external source that is physically separate from the portable brew device. The pump draws the hot water through the tube and facilitates pressurization of the hot water. The battery provides power to the pump to enable operation of the pump. The holder carries a substance, or a medium, to be brewed (e.g., coffee, tea, another hot beverage, a bouillon, a vegetable stock, etc.). The needle receives the hot water from the tube and introduces the hot water into the media to provide a brewed liquid. The brewed liquid exits the portable brew device through the outlet. Unlike other known battery-operated systems, the brew device only utilizes the power from the battery to operate the pump, a valve, and one or more low voltage input/output devices.

A brew device of this disclosure is lightweight and has dimensions that make it highly portable. Without limitation, a brew device of this disclosure may weigh about two pounds or less. The brew device may be collapsed to a height of about 7 inches or less, a depth of about 3 inches or less, and a width of about 2½ inches or less. More specifically, a housing of the brew device may have a height of about 7 inches or less, a depth of about 3 inches or less, and a width of about 2½ inches or less.

A brew device of this disclosure may lack a reservoir for water. Instead, the brew device may be connectable to and draw water from an external source of water (e.g., a water bottle, a larger container, etc.). More specifically, a tube may connect the brew device to the external source of water. The lack of a reservoir may contribute to the portability of the brew device.

The brew device may include a housing and a support. The support may be placed in deployed arrangement, in which the support may be associated with the housing in a manner that elevates the housing above a surface and a vessel (e.g., a cup, a mug, etc.) resting on the surface. The support may also be placed in a stowed arrangement. Optionally, while in the stowed arrangement, the support may be stowed in the housing. As another option, the support may remain connected to the housing as it is deployed and stowed.

The brew device may include a holder, which may carry a substance, or a medium, to be brewed. The holder may be assembled with the housing without significantly adding to the dimensions of the housing. For example, when assembled with the housing, the holder may not add to a height, a depth, or a width of the housing. Thus, the overall dimensions of the brew device may remain substantially the same regardless of whether the holder is assembled with the housing.

The housing of the brew device may carry a battery, a pump, conduits, electronics, and input/output devices. In addition, the housing may carry an injector. The housing or the optional holder of the brew device also carries, defines, or otherwise includes a dispenser.

The battery may be rechargeable (e.g., a lithium ion (Li-ion) battery, a nickel-cadmium (NiCd) battery, a nickel-metal hydride (NiMH) battery, etc.) or disposable. In embodiments where the brew device includes a rechargeable battery, the housing of the brew device may also include a charger (e.g., a suitable port, wiring, and electronics, etc.), which facilitates recharging of the battery when electrically coupled to, or “plugged into,” an external power supply (e.g., another battery, an electrical outlet in a vehicle, mains power, etc.). The battery is a portable source of power for the pump, the electronics, and the input/output devices. Since the housing of the brew device does not carry a reservoir, the battery may be relatively large and, thus, have a high capacity that enables operation of the brew device for extended periods of time, allowing for large volumes (e.g., several cups, one or more quarts, one or more gallons, etc.) of water to be heated.

The pump may draw water from an external source into a conduit carried by the housing. Optionally, the pump may also deliver air to the external source. The pump may also pressurize the water. Any suitable type of pump may be used. Water flows through or past the pump (e.g., through another conduit, directly, etc.) to the injector. The injector may comprise a needle, a nozzle, or the like. The injector introduces the heated water, under pressure, to a location that may carry a medium to be brewed. In some embodiments, the injector may introduce the pressurized water into an optional holder. Functioning in conjunction with the pump, the injector may further pressurize the water.

The electronics control operation of electrical components of the brew device (e.g., the battery, the pump, the heater, etc.). Without limitation, the electronics may include circuitry, switches, controllers and/or processors, ports, and the like.

The input/output devices may enable a user of the brew device to interact with the electronics to provide the user with some control over operation of the brew device. As a few examples, the input/output devices may enable a user to turn the brew device on or off, provide inputs that control operation of the brew device (e.g., a volume of liquid to be brewed, a type of liquid to be brewed, a range of acceptable brewing temperatures, etc.), and receive outputs regarding the input parameters and information on the status of the brew device (e.g., whether the brew device is on or off, a water temperature, a temperature of a heated or brewed liquid, a volume of liquid dispensed by the brew device, an elapsed time of the brewing processes, a time remaining until the brewing process is complete, a remaining battery life, etc.).

Notably, the brew device may lack a heater. Instead, the external source of water from which the brew device draws water may comprise a heated external source of water. Without a heater, power requirements of the battery may be significantly reduced, as power from the battery need only be used to pump the water from the source and through other components of the brew device and to operate low voltage electronic components (e.g., one or more input/output devices, etc.) of the brew device.

In another aspect, a brewing system is disclosed. The brewing system may include a brew device, a tube, an external source of water, and one or more vessels. The brew device may comprise any embodiment of brew device within the scope of this disclosure. The tube enables water to be drawn into the brew device from the external source of water. The external source of water may comprise any suitable source of water. The vessel may comprise a pot, one or more cups, one or more mugs, one or more insulated bottles, or the like.

The brew device is lightweight and very portable making it easy to take along on short or long trips for backpacking or any outdoor activity.

A method for brewing a substance, or a medium, includes placing a support for a brew device in a deployed arrangement and positioning the support on a surface, including positioning the brew device over the surface. The support may elevate the brew device over the surface. The brew device may be provided with a substance or medium to be brewed. For example, the substance or medium to be brewed may be placed in a holder, which may be coupled to the brew device.

Flow communication may be established between the housing and an external source of water. A vessel may be placed beneath the brew device. The brew device may be actuated. As the brew device is actuated, water (e.g., heated water, etc.) may be drawn from the external source into the brew device. The water may be introduced into a substance, or medium, to be brewed. For example, the water may be used to brew a substance, or a medium, such as a hot drink (e.g., coffee, tea, herbal tea, hot chocolate, cider, etc.), a broth, a vegetable stock, a medicine, or the like. The brewed substance, or medium, may then be dispensed from the brew device into the vessel. Brewing may continue a desired volume (e.g., a cup, a plurality of cups, a quart, a plurality of quarts, a gallon, a plurality of gallons, etc.) of a brewed substance, or medium, has been brewed.

Once use of the brew device is complete, it may be disconnected from the external source of water and removed from the surface. The support may be placed in a stowed arrangement and, optionally, stored in a housing of the brew device. The brew device may also be cleaned.

Other aspects of the disclosed subject matter, as well as features and advantages of various aspects of the disclosed subject matter, should become apparent to those of ordinary skill in the art through consideration of the ensuing description, the accompanying drawings, and the appended claims.

### BRIEF DESCRIPTION OF THE DRAWINGS

In the drawings:

FIG. 1 is an front view of an embodiment of a brew device;

FIGS. 1A, 1B, and 1C are front view of alternative embodiments of brew devices;

FIG. 2 is a rear view of the brew device shown in FIG. 1;

FIG. 3 is a rear orthogonal view of the brew device shown in FIG. 1 with a cutaway view of a support receptacle of the brew device, showing a support of the brew device in a stowed arrangement;

FIG. 4 is a rear orthogonal view of the brew device shown in FIG. 1 with a cutaway view of the support receptacle of the brew device, showing an inner leg and feet of the support in a partially deployed arrangement;

FIG. 5 is a rear orthogonal view of the brew device shown in FIG. 1 with a cutaway view of the support receptacle of the brew device, showing an outer leg, the inner leg, and the feet of the support in a further partially deployed arrangement;

FIG. 6 depicts various positions of the feet of the support of the brew device shown in FIG. 1, including a stowed arrangement, two partially rotated arrangements, and a deployed arrangement;

FIG. 7 is a front orthogonal view of the brew device shown in FIG. 1, with the support in a fully deployed arrangement;

FIG. 8 is a cross-sectional representation of the brew device of FIG. 1 illustrating various internal components of the brew device;

FIG. 9 provides a close-up assembly view of a pump and associated components of the brew device of FIG. 1;

FIG. 10 is an enlarged view of an embodiment of an injector of the brew device of FIG. 1;

FIG. 11 is an assembly view depicting an arrangement of a holder for media to be brewed and various parts of the brew device of FIG. 1 that function with the holder and any medium carried by the holder;

FIG. 12 is another cross-sectional representation of the brew device of FIG. 1, illustrating other internal components of the brew device;

FIG. 13 is a side view showing the support of the brew device of FIG. 1 in a fully deployed arrangement that will elevate the brew device at a first elevation over a surface;

FIG. 14 is a side view showing the support of the brew device of FIG. 1 in a fully deployed arrangement that will elevate the brew device at a second elevation over the surface; and

FIG. 15 illustrates an embodiment of a system for heating water and/or brewing a medium.

### DETAILED DESCRIPTION

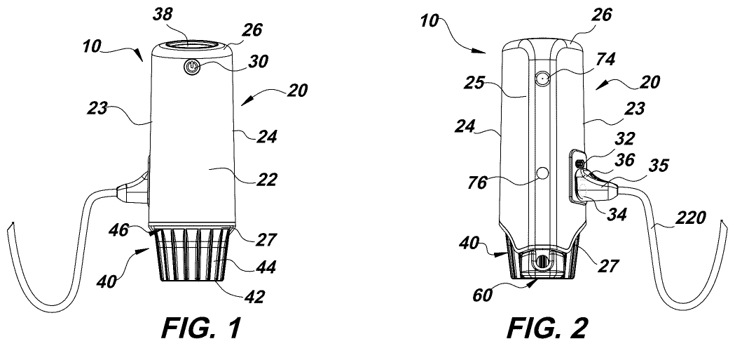

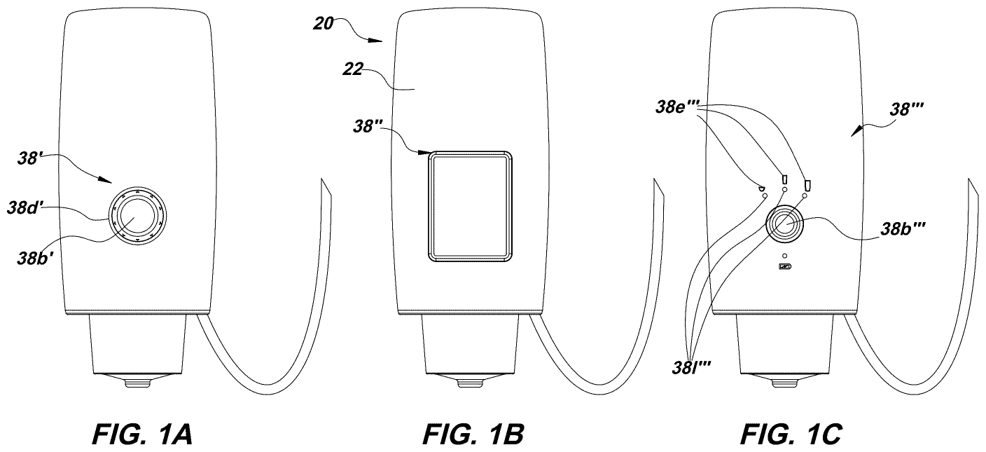

As illustrated by FIGS. 1-5 and 7, an embodiment of a brew device 10 is depicted. The brew device 10 may be portable and may operate in environments where power is not readily available. Stated another way, the brew device 10 may be battery-powered. The brew device 10 may lack a reservoir for water, which may provide space for a larger, higher capacity battery, thereby increasing a heating and brewing capacity of the brew device 10. Thus, although the brew device 10 may be portable and battery-powered, the brew device 10 may be used to continuously heat large volumes (e.g., several cups, pints, quarts, liters, gallons, etc.) of water and/or to brew significant volumes (e.g., several cups, pints, quarts, liters, gallons, etc.) of brewed liquids.

The brew device 10 may include a housing 20, a holder 40, and a support 60. The housing 20 may carry components that heat water and/or brew a substance, or a medium. The holder 40 may hold a medium to be brewed and couple to the housing 20 in a manner that enables components carried by the housing 20 to brew the medium. The support 60 may elevate the housing 20 above a surface.

The housing 20 of the brew device 10 may have dimensions and, thus, a size, that makes the brew device 10 portable. For example, the housing 20 may have a height of about 7 inches or less, a depth of about 3 inches or less, and a width of about 2½ inches or less. The housing 20 may include a front 22, sides 23 and 24, a rear 25, a top 26, and a bottom 27.

As illustrated by FIG. 1, the holder 40 of the brew device 10 may be coupled with the housing 20 at a location adjacent to the bottom 27 of the housing 20. In some embodiments, the holder 40 may be partially received by the bottom 27 of the housing 20. The holder 40 may be removably coupled to the housing 20. For example, the holder 40 may be rotatably coupled to the housing 20 (e.g., with helical threads, with a locking slot, etc.), snap-fit to the housing, or secured to the housing in any other suitable manner.

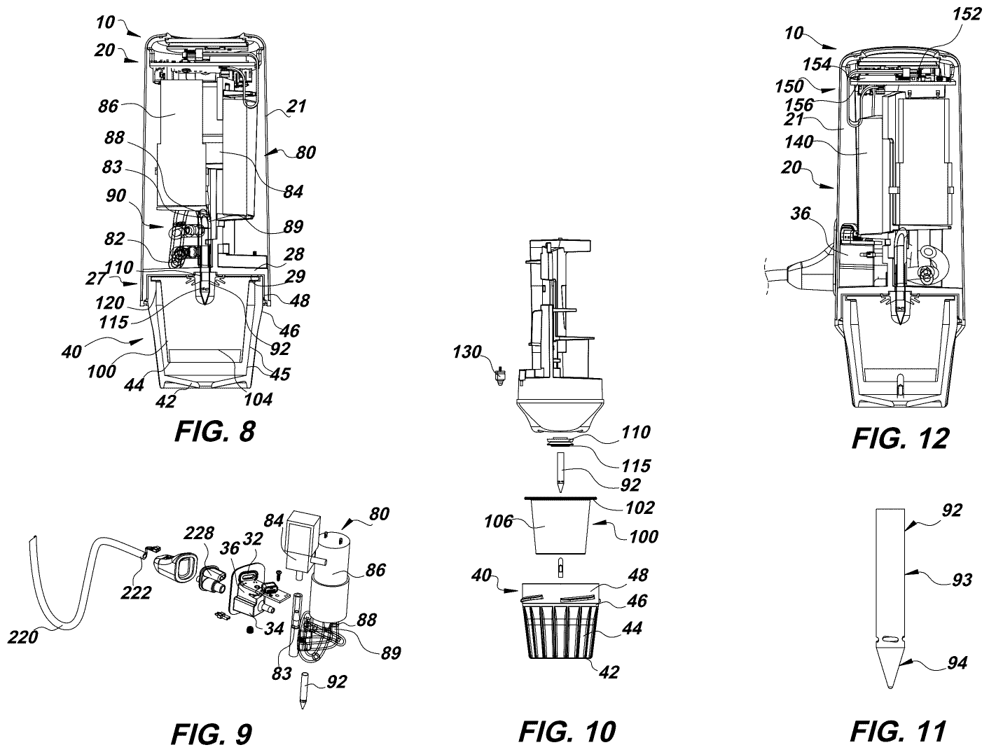

The embodiment of holder 40 depicted by FIG. 1 includes a base 42, a side wall 44, an upper rim 46, and a coupler 48 (see FIG. 10). The holder 40 may have a frustoconical shape (i.e., the shape of a truncated, or cut-off, cone). The base 42 may be circular and somewhat conical in shape, with a dispensing aperture 43 (see FIG. 8) being located in a center of the base 42 (e.g., defining a vertex of the cone, etc.). The side wall 44 may extend upwardly and outwardly from an outer periphery 43 of the base 42 (i.e., it may taper outwardly) to its upper rim 46. Together, the base 42 and the side wall 44 may define a receptacle 45 (see FIG. 8), which may receive the substance, or medium, to be brewed. Without limitation, the receptacle 45 may have a shape that enables it to receive a cartridge 100 (FIG. 10), such as a K-cup (i.e., a Keurig cup), a pod, or the like. Briefly referring to FIG. 9, the coupler 48 may be connected to the upper rim 46. The coupler 48 may include one or more features that enable the holder 40 to be quickly connected to and/or disconnected from the bottom 27 of the housing 20. For example, the coupler 48 may include the depicted helical threads, one or more slots with notches that enable the holder 40 to lock into place relative to the housing 20, one or more snap-fit features (e.g., a semicircular thread, a series of protrusions, etc.), or the like.

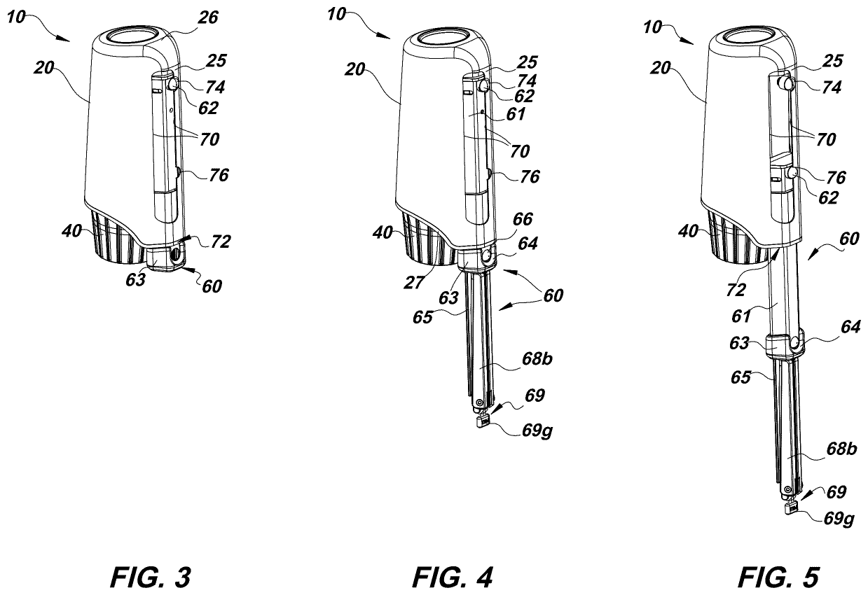

A portion of the support 60 of the brew device 10 can be seen in FIG. 2. As illustrated in FIG. 2, the support 60 is in a collapsed arrangement, or a stowed arrangement. As shown in FIGS. 3-7, the support 60 may include one or more legs 61, 65 and feet 68a and 68b extendable from the leg(s) 61, 65. More specifically, the support 60 may include an outer leg 61, or an outer riser, and an inner leg 65, or an inner riser. The outer leg 61 may slide relative to (e.g., in and out of) a support receptacle 70 at the rear 25 of the housing 20. The inner leg 65 may slide relative to (e.g., in and out of) a receptacle (not shown) in the outer leg 61. The outer leg 61 may include a button pin 62, which may be spring-loaded, near a top end of the outer leg 61. As will be described in further detail hereinafter, the button pin 62 may be used to fix the outer leg 61 in a plurality of positions relative to the support receptacle 70 and, thus, the housing 20 of the brew device 10. A base 63 may be provided on a bottom end of the outer leg 61. The base 63 may include an opening through which the inner leg 65 slides. The base 63 may also include a hole 64 that receives a button pin 66 near a top end of the inner leg 65.

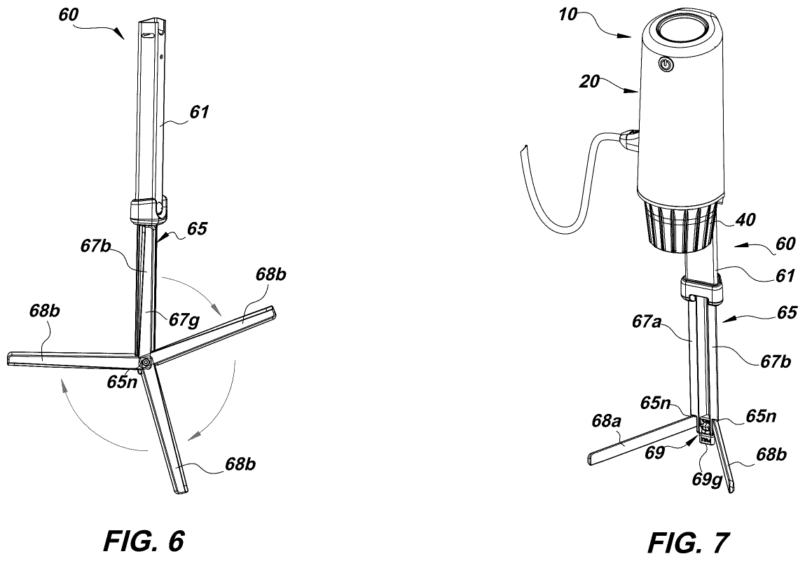

The inner leg 65 may include sides 67a and 67b (see FIGS. 6 and 7) that diverge from back to front. For example, the inner leg 65 may have a trapezoidal cross-sectional shape taken along its length, although other cross-sectional shapes, such as triangular cross-sectional shapes, etc., may also have sides that diverge from back to front.

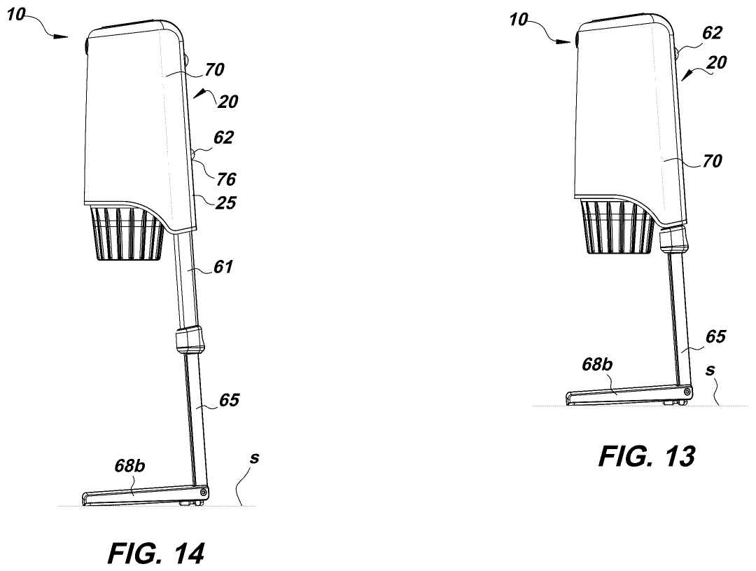

The support 60 may also include a foot 68a, 68b positioned against each side 67a, 67b. The feet 68a and 68b may rotate about hinge pins (e.g., screws and polytetrafluoroethylene (PTFE) washers, etc.) that connect the feet 68a and 68b to the sides 67a and 67b near the bottom of the inner leg 65. Since the sides 67a and 67b of the inner leg 65 diverge from back to front, as the feet 68a and 68b rotate forward to their deployed orientations (e.g., perpendicular, at an acute angle, etc.; see FIGS. 13 and 14) relative to the inner leg 65, the feet 68a and 68b extend in different directions from one another.

A pull cord 69 with a grip 69g at an end thereof may be coupled to and extend from a bottom of the inner leg 65.

Optionally, while in its stowed arrangement, the support 60 may be stored in the support receptacle 70 at the rear 25 of the housing 20. The support receptacle 70 may comprise an elongated receptacle that extends along a height of the housing 20, from an opening 72 defined by the bottom 27 of the housing 20 (see FIG. 2), toward the top 26 of the housing 20 (see FIG. 2). While in its stowed arrangement, the support 60 may slide into the support receptacle 70, as shown in FIGS. 1 and 2, and at least partially out of the support receptacle 70, as shown in FIGS. 3-7. As depicted by FIGS. 2-5 and 7, one or more holes 74, 76, etc., may extend from an interior of the support receptacle 70 to an exterior of the rear 25 of the housing 20. Each hole 74, 76, etc. may receive a button pin 62, 66 of the support 60 (e.g., of the outer leg 61, of the inner leg 65, etc.) as the support 60 slides along the support receptacle 70 (e.g., by pulling the pull cord 66 and the outer leg 61 from the support receptacle 70 and/or the inner leg 65 from the outer leg 61, by pushing the inner leg 65 into the outer leg 61 and/or the outer leg 61 into the support receptacle 70, etc.), fixing a position of the support 60 along the support receptacle 70 and, thus, defining a distance the support 60 protrudes beyond the bottom 27 of the housing 20. Further detail regarding the features and operation of the support 60 will be provided hereinafter.

Various other features of the brew device 10 can also be seen in FIGS. 1-7.

As FIG. 1 shows, a power switch 30 may be accessible from the front 22 of the housing 20. The power switch 30 may comprise any suitable switch that enables an individual to turn power to electronic and electrical components of the brew device on and off. Without limitation, the power switch 30 may comprise a button. More specifically, the button may include light that off when the power switch 30 is off and turns on, or emits light, when the power switch 30 is on. Alternative embodiments of the power switch 30 include toggle switches, sliding switches, dials, and the like.

The housing 20 may carry one or more communication ports 32. As shown in FIG. 2, a communication port 32 may be accessible from the side 23 of the housing 20. The communication port 32 may facilitate charging of a battery of the brew device 10 and/or enable communication with one or more electronic components (e.g., controllers, processors, etc.) of the brew device 10. As an example, the communication port 32 may comprise a USB-C port. Other types of wired communication ports may also be used, as may wireless devices (e.g., wireless charging devices, wireless communication devices, etc.). The communication port 32 may be protected with a cover (not shown), which may be removed from the communication port 32 to access the communication port 32 for use and repositioned over the communication port 32 when access to the communication port 32 is no longer needed.

With continued reference to FIG. 2, the brew device 10 may include an intake port 34. The intake port 34 may enable water from an external source (not shown) to flow into the brew device 10. The intake port 34 may be accessible through the housing 20. As shown, the intake port 34 may be located in a side 23 of the housing 20. The intake port 34 may extend through a coupler 35 (FIG. 10), which may have a configuration that enables it to be coupled to a tube 220 that draws water from the external source (not shown). The configuration of the coupler 35 may be received and engaged by an opening of the tube 220 or an opening associated with the tube 220.

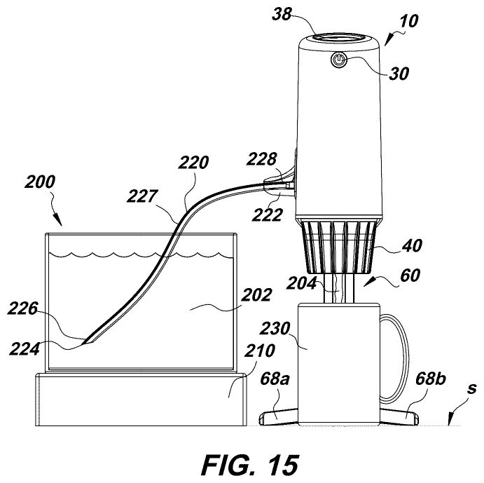

Optionally, the brew device 10 may include another communication port 36 (see also FIGS. 10 and 12). The other communication port 36 may communicate with a processor or controller 154 of electronics 150 (FIG. 12) of the brew device 10. The other communication port 36 may receive signals from a sensor external to the brew device 10. For example, the other communication port 36 may facilitate the communication of signals from a temperature sensor 226 (FIG. 15) external to the brew device 10 to a processor or controller 154 of the brew device. The other communication port 36 may be accessible through the housing 20. The other communication port 36 may located adjacent to the intake port 34. For example, the other communication port 36 may be located in the side 23 of the housing 20, next to the intake port 34. The other communication port 36 may have a configuration that enables it to be coupled to a connector 228 that protrudes from a first end 222 of a tube 220 (FIG. 9) that transports water from the external source (not shown) of water into the brew device 10. The configuration of the other communication port 36 may enable it to receive and engage the connector 228 that protrudes from the first end 222 of the tube 220.

One or more input/output devices 38 may also be accessible through the housing 20. FIGS. 1 and 12 show an embodiment of an input/output device 38 that is accessible from the top 26 of the housing 20. That embodiment of input/output device 38 comprises a touch screen that enables an individual to make inputs that control and/or modify operation of the brew device 10 and to view outputs regarding the operation of the brew device 10. More specifically, the input/output device 38 may comprise an organic light-emitting diode (OLED) touch screen, a touch-sensitive liquid crystal display (LCD), or the like. The touch-sensitivity of such an input/output device 38 may be surface capacitive touch-sensitivity, projected capacitive touch-sensitivity, resistive touch sensitivity, or the like.

FIGS. 1A, 1B, and 1C show other embodiments and other possible locations for input/output devices 38′, 38″, and 38″, respectively. FIG. 1A illustrates an embodiment of input/output device 38′ that includes a dial 38d′ (e.g., a mechanical dial, an infinitely variable mechanical dial, a track wheel, etc.) and a push button 38b′ in the center of the dial 38d′ to enable a user to select a volume of a liquid to be brewed and start and/or stop the brewing process. FIG. 1B illustrates an embodiment of input/output device 38″ that includes a touch screen on the front surface 22 of the housing 30. FIG. 1C illustrates an embodiment of an input/output device 38″ that includes a push button 38b′″ that may be pushed one or more times to select a volume of liquid to be brewed and indicator lights 381″ and corresponding indicia 38i″ to provide an indicator of the selected volume.

Turning now to FIGS. 8-12, various internal components of the brew device 10 will be described.

FIG. 8 shows an interior 21 3 of the housing 20, including an internal base 28 of the housing 20. The housing 20, within its interior 21, carries a pumping system 80 and an injection system 90 of the brew device 10. FIG. 9 provides further detail regarding the pumping system 80. FIG. 10 provides further detail regarding the injection system 90. The pumping system 80 may include an intake conduit 82 coupled to the intake port 34 shown in FIGS. 2 and 9. The intake conduit 82 may extend to branched coupling 83 (e.g., a T connector, a Y connector, etc.). One branch of the branched coupling 83 is connected to a valve 84, while the other branch of the branched coupling 83 is connected to an inlet (not shown) of a pump 86.

The pump 86 may be able to withstand high temperatures (e.g., at least about 212° F., or 100° C., etc.). The pump 86 may generate a sufficient suction to draw water from an external source (not shown) into the intake port 34 and through the intake conduit 82. Water may exit the pump 86 through an outlet 88, where it enters an output conduit 89, which delivers water to the injection system 90.

The valve 84 may have two states—an open state and a closed state. The valve 84 is normally in the closed state. However, when a brewing cycle is almost complete, the valve 84 may open to atmosphere to enable air to flow into the pump 86 behind water, enabling the pump 86 to evacuate substantially all of the remaining water from the output conduit 89 and the injection system 90. In addition, when the valve 84 is in the open state, water from the intake conduit 82 may flow backward, or drain, out of the intake port 34, through a tube 220 coupled to the intake port 34, and back to its external source (not shown), by which the water may be collected and, optionally, reheated.

With continued reference to FIGS. 8 and 10, along with added reference to FIGS. 9 and 11, the injection system 90 includes a needle 92, which receives the pressurized water from the output conduit 89. The needle 92 extends through the internal base 28 of the housing 20 to a location where the receptacle 45 of the holder 40 will place a substance, or a medium 106, to be brewed when the holder 40 is assembled with the housing 20. The needle 92 may comprise a hollow tube 93 with a tip 94. The tip 94 may be blunt, but able to pierce a cover 102 (e.g., a foil cover, a paper cover, etc.) on a cartridge 100 (e.g., a K-cup, a pod, etc.) that has been placed in the receptacle 45 of the holder 40. The hollow tube 93 and/or the tip 94 may include openings 96 through which water may be forced into the medium 106 within the receptacle 45 of the holder 40. In a specific embodiment, the openings 96 in the hollow tube 93 and/or the tip 94 of the needle 92 may comprise four (4) angular slits. The openings 96 may cause the water to fan outward in a manner that causes the water to substantially uniformly cover the top surface of the medium 106, enabling the water to fully extract the flavor of the medium 106.

A needle support 110 may be secured in place beneath a bottom surface 29 of the internal base 28 to secure the needle 92 in place. The needle support 110 may include an aperture (not shown) through which the needle 92 extends and to which the needle 92 may be fixed.

A filter seal 115 may be located beneath the needle support 110 and surround the needle 92. The filter seal may create a seal (e.g., a pressurized seal, etc.) between the needle support 110 and the needle 92 to prevent water that has been forced out of the needle 92 and introduced into the medium 106 from exiting the cover 102 of the cartridge 100, if any, within which the medium 106 is contained. Without limitation, the filter seal 115 may comprise a gland seal, or a gland insert. In some embodiments, the filter seal 115 may include a plurality of lips to enable it to ensure robust sealing between the needle 92 and the cover 102 of the cartridge. The filter seal 115 may be made from a readily compressible, compliant, resilient material. The material of the filter seal 115 may have a low durometer (e.g., a hardness measured on the Shore A scale or at the lower end of the Shore D scale, etc.). Optionally, the filter seal 115 may be made from a silicone.

Water that is introduced into a cartridge 100 may exit a base 104, or a filter, of the cartridge 100 (e.g., under pressure, under force of gravity, etc.), where it may enter a space between the base 104 of the cartridge 100 and the base 42 of the holder 40, and may then flow out of the aperture 43 in the base 42 of the holder 40, where it may be collected by a container (not shown) beneath the holder 40.

An interior surface of the bottom 27 of the housing 20 may include a coupler 120 that mutually engages the coupler 48 of the holder 40 and, thus, that enables the coupler 48 to couple the holder 40 to the housing. As depicted, the coupler 120 of the housing 20 includes helical threads that enable the holder 40 to be screwed onto the housing 20. Alternatively, the coupler 120 may comprise protrusions that are cooperate with locking slots of the coupler 48, snap-fit features that cooperate with snap-fit features of the coupler 48, etc.

Optionally, the brew device 10 may include a safety switch 130. The safety switch 130 may be associated with the coupler of the housing 120 and/or the bottom surface 29 of the internal base 28 of the housing 20. The location and a configuration of the safety switch 130 may enable it interact with the holder 40 or its coupler 48. For example, when the holder 40 is not properly or completely assembled with the housing 20, the safety switch 130 may be in an off position that prevents the brew device 10 from functioning. Alternately, when the holder 40 is properly and completely assembled with the housing 20, it may move the safety switch 130 to an on position that enables the brew device 10 to function. The safety switch 130 may communicate with the electronics 150 (FIG. 12) of the brew device 10.

FIG. 12 shows another portion of the interior 21 of the housing 20 and additional components of the brew device 10 carried by the housing 20. In particular, FIG. 12 illustrates a battery 140 and electronics 150 of the brew device 10. The battery 140 may be rechargeable or disposable. Examples of rechargeable batteries include but are not limited to lithium ion (Li-ion) batteries, nickel-cadmium (NiCd) batteries, nickel-metal hydride (NiMH) batteries, and the like. Without limitation, the battery 140 may have a sufficient capacity to enable the brew device 10 to produce about 20 cups (i.e., about 160 fl. oz., or about 4.7 L) to about 30 cups (i.e., about 240 fl. oz., or about 7 L) of a brewed liquid.

In embodiments where the battery 140 is rechargeable, the electronics 150 of the brew device 10 may also include a charger 152 (e.g., a suitable port, wiring, charging board, and electronics, etc.), which facilitates recharging of the battery 140 when the brew device 10 is electrically coupled to, or “plugged into,” an external power supply (e.g., another battery, an electrical outlet in a vehicle, mains power, etc.). The charger 152 may provide integral protection for the battery 140.

The electronics 150 of the brew device 10 may also include one or more processors or controllers 154. The processor(s) or controller(s) 154 may communicate (e.g., by way of electrical circuits and electrical connections on circuit boards 156 (see also FIG. 8), wires (not shown), etc.) the battery 140, any charger 152, the power switch 30 (FIG. 1), communication ports 32 and 36 (FIG. 2), and any wireless communication devices, the input/output device(s) 38 (FIG. 1), the pump 86 (FIGS. 8 and 9), the optional safety switch 130 (FIG. 10), and any other electrical or electronic components of the brew device 10. The processor(s) or controller(s) 154 may control operation of the pump 86, the input/output device(s) 38, and other electrically operated and/or electronic components of the brew device 10. The processor(s) or controller(s) 154 may operate under programmed logic that governs operation of the brew device 10, such as a volume of liquid to pass through a medium 106 (FIG. 10) to be brewed (which may be infinitely variable) and initiation of a brewing cycle. The input/output device(s) 38 may enable a user to select the volume of water to be used in brewing, to control when the brewing cycle begins, to enable a user to select or identify a type of media to be brewed (e.g., coffee, tea, herbal tea, hot chocolate, cider, broth, stock, medicine, etc.), to input a desired temperature for the type of media to be brewed, to select or input a volume of water to be drawn into and/or dispensed by the brew device 10, to display a remaining battery life, to display a temperature of the water drawn into the brew device 10, to display an elapsed time of the brewing processes, to display a time remaining until the brewing process is complete, to display a volume of water drawn into the brew device 10, to display a volume of liquid dispensed by the brew device 10, to display errors in the operation of the brew device 10, etc.

With returned referenced to FIGS. 3-7, the support 60 of the brew device 10 is described in further detail. FIG. 4 shows the support 60 in a partially deployed arrangement, in which the inner leg 65 of the support 60 is partially withdrawn from outer leg 61 and the feet 68a and 68b that are positioned against the sides 67a and 67b of the inner leg 65 are completely withdrawn from the outer leg 61. For example, the grip 69g of the pull cord 69 may be grasped between a thumb and finger and the pull cord 69 pulled away from the housing 20 of the brew device 10 to extend the inner leg 65 and the feet 68a and 68b from the outer leg 61 to extend the inner leg 65 and the feet 68a and 68b from the housing 20. As illustrated, the button pin 66 of the inner leg 65 protrudes from the hole 64 through the base 63 of the outer leg 61, fixing the distance the inner leg 65 protrudes from the bottom 27 of the housing 20. In this arrangement, the outer leg 61 remains in the support receptacle 70 and the button pin 62 of the outer leg 61 remains within an upper hole 74 through the rear 25 of the housing 20.

FIG. 5 depicts a further partially deployed arrangement, in which the outer leg 61 is at least partially withdrawn from the support receptacle 70. In this arrangement, the button pin 62 of the outer leg 61 may reside within the lower opening 76 to hold the outer leg 61 in place.

In FIG. 7, the inner leg 65 and the feet 68a and 68b are shown in a fully deployed arrangement, in which the feet 68a and 68b are rotated forward, away from the sides 67a and 67b of the inner leg 65. For example, as shown in FIG. 6, the feet 68a and 68b may rotate about hinge pins that connect the feet 68a and 68b to the sides 67a and 67b near the bottom of the inner leg 66. Since the sides 67a and 67b of the inner leg 66 diverge from back to front, as the feet 68a and 68b rotate forward to their deployed orientations (e.g., perpendicular, at an acute angle, etc.) relative to the inner leg 65, the feet 68a and 68b extend in different directions from one another.

Optionally, as shown in FIG. 6, rotation of the feet 68a and 68b may include pushing each foot 68a, 68b backward from a groove 67g in the corresponding side 67a, 67b of the inner leg 65. Each foot 68a, 68b is then rotated about 270° until it extends forward and is engaged by a notch 65n (see also FIG. 7) in the bottom of the corresponding side 67a, 67b of the lower leg 65. Such an arrangement may prevent the feet 68a and 68b from collapsing back onto the inner leg 65 when the support is in a deployed arrangement and supports the brew device 10 above a surface.

FIG. 13 shows the support elevating the housing 20 and the remainder of the brew device 10 at a first elevation over a surface S. As shown in FIG. 14, the outer leg 61 may be withdrawn from the support receptacle 70 (note the placement of the button pin 62 of the outer leg 61 in the lower hole 76 in the rear 25 of the housing 20 in FIG. 20) to further elevate the housing 20 and the remainder of the brew device 10 over the surface S (e.g., at a second elevation that exceeds the first elevation, etc.).

Once use of the brew device 10 is complete, the feet 68a and 68b may be rotated back against the sides 67a and 67b, respectively, of the inner leg 65, the button pin 66 may be depressed, and, while depressing the button pin 66, the inner leg 65 and feet 68a and 68b may be pushed back into the outer leg 61. If the outer leg 61 was withdrawn from the support receptacle 70, the button pin 62 of the outer leg 61 may be depressed to remove it from the lower opening 76 and the outer leg 61 may be pushed into the support receptacle 70.

Turning now to FIG. 15, an embodiment of a system 1 for heating water and/or brewing a medium is depicted. The system 1 includes the brew device 10, an external source 200 of water 202, a heat source 210 for heating the water 202, and a tube 220 for conveying the water 202 from the external source 210 to the brew device 10. The system 200 also includes one or more containers 230 into which the brew device 10 dispenses a brewed liquid 204.

The external source 200 may comprise any suitable container for water 202. Optionally, a configuration of the external source 200 and/or the material(s) from which it is formed may enable it to be heated to heat the water 202 therein. As an example, the external source 200 may comprise a pot (e.g., an iron pot, a stainless steel pot, an aluminum pot, a ceramic pot, etc.).

The heat source 210 may be associated with the external source 200 or it may heat water 202 before the water 202 is introduced into the external source 200 or after the water 202 flows out of the external source 200. In embodiments where the heat source 210 heats water 202 within the external source 200, the heat source 210 may comprise a portable source of heat (e.g., a stove, such as a camp stove, a hot plate, a fire pit, etc.) or an in situ source of heat (e.g., a campfire, etc.). In other embodiments, the heat source 210 may heat the water 202 as it flows through a conduit that can withstand the heat generated by the heat source 210, such as the hose 220 of the system 1.

At the first end 222 of the tube 220, an intake lumen of the tube 220 may be connectable to the intake port 34 (FIGS. 2 and 9) of the brew device 10. The opposite, second end 224 of the tube 220 may be placed the water 202 or coupled to the external source 200 of water 202. The second end 224 may, as shown, be cut at a non-perpendicular angle to a longitudinal axis of the tube 200, include a plurality of holes, or include another feature that prevents an opening in the tube from sealing against a surface of the external source 200 in a manner that would otherwise prevent water 202 from being drawn into the intake lumen of the tube 220. The tube 220 may be made of a high temperature food grade silicone. The tube 220 may have any of a variety of lengths.

In some embodiments, the tube 220 may carry a temperature sensor 226. The temperature sensor 226 may be positioned adjacent to the second end 224 of the tube 220. The position of the temperature sensor 226 may enable it to determine the temperature of the water 202 drawn into the brew device 10. The temperature sensor 226 may communicate with a processor or controller 154 of the electronics 150 (FIG. 12) of the brew device 10 (e.g., by wiring 227 and a connector 228 that couples to the communication port 36 (FIGS. 9 and 12) of the brew device 10, etc.). Based on the temperature of the water 202, the processor or controller 154 may determine a flow rate for the water 202 that will provide for optimal brewing of a selected medium 106 (FIG. 10) and cause the pump 86 (FIGS. 8 and 9) of the brew device 10 to operate at that flow rate. The processor or controller 154 (FIG. 12) may prevent the brew device 10 from operating if the water 202 is too cold or too hot for the type of medium 106 to be brewed or the user's preference for the temperature of the medium 106 to be brewed (which may be input into the processor or controller 154 with the input/output device 38 (FIG. 1).

Optionally, the tube 220 may include two lumens. While the intake lumen may convey water 202 from the external source 200 to the brew device 10, another lumen, or raceway, may carry wires from a sensor (e.g., wiring 227 associated with a temperature sensor 226, etc.). to a communication port 36 (FIG. 3) of the brew device 10 to enable the transmission of signals from the sensor to the processor(s) or controller(s) 154 of the electronics 150 (FIG. 12) of the brew device 10.

With continued reference to FIG. 15, use of the system 1 may include heating water 202 from the external source 200 (e.g., with the heat source 210 etc.). The water 202 may be heated to a temperature sufficient for brewing a medium 106 (FIG. 7). For example, the water 202 may be heated to a temperature of about 160° F., about 170° F., about 180° F., about 190° F., about 200° F., etc.).

In addition, the brew device 10 may be set up. A cartridge 100 that holds the medium 106 (FIG. 9) (e.g., a single serving, etc., of the medium 106) to be brewed may be placed in the holder 40 of the brew device 10 and the holder 40 with the cartridge 100 therein may be coupled with the bottom 27 of the housing 20 of the brew device 10. More specifically, with returned reference to FIGS. 8 and 10, the coupler 48 of the holder 40 may be aligned with the coupler 120 in the bottom 27 of the housing 20, pressed onto the needle 92, then twisted to lock the holder 40 the housing 20. Rotating the holder 40 into the housing 20 presses the cover 102 of the cartridge 100 against the filter seal 115 to provide a leakproof system. Furthermore, the coupler 48 of the holder 40 is pushed against the safety switch 130, engaging the safety switch 130 and enabling the brew device 10 to operate.

Setting up the brew device 10 may also include coupling the first end 222 of the tube 220 to the intake port 34 (FIGS. 2, 9, and 12) of the brew device 10 and placing the second end 224 of the tube 220 in the water 202 or coupling the second end 224 of the tube 220 to the external source 200 of water 202. Setup of the brew device 10 may further include deploying support 60 and placing the feet 68a and 68b of the support 60 on a surface S to elevate a remainder of the brew device 10 over the surface S. A container 230 may be placed beneath a dispensing aperture 43 (FIGS. 8 and 12) of the holder 40.

When the water 202 is heated to a sufficient temperature, the brew device 10 may be actuated (e.g., with the power switch 30, etc.). Optionally, the temperature of the water 202 may be monitored. Operation of the brew device 10 may be controlled based on the temperature of the water 202 (e.g., operation of the brew device 10 may not commence if the temperature of the water 202 is too cold or too hot, the rate at which water 202 flows into and through the brew device 10 may be based on the temperature of the water 202, etc.). The input/output device(s) 38 of the brew device 10 may be used to input a volume of water 202 to be used to brew the medium 106. In addition, the input/output device(s) 38 may enable an individual to start the brewing process. Once brewing has commenced, the input/output device(s) 38 may optionally output information regarding the brewing process, such as a volume of water 202 that has already flowed through the brew device 10, a temperature of the water 202 and/or the brewed liquid 204, an elapsed time of the brewing processes, a time remaining until the brewing process is complete, a battery status, and the like. The input/output device(s) 38 may also enable a user to pause and restart the brewing process so that the user can change replace the cartridge 100 within the holder 40.

The brewing process results in a brewed liquid 204 that is dispensed from the holder 40 into one or more containers 230.

Once the brewing process is complete, the brew device 10 may be turned off (e.g., with the power switch 30, etc.) and the tube 220 may be disconnected. The cartridge 100 may be removed from the holder 40 and the holder 40 and brew device 10 may be cleaned. In addition, the support 60 may be placed in its stowed arrangement and stored within the support receptacle 70.

Although this disclosure provides many specifics, these should not be construed as limiting the scope of any of the claims that follow, but merely as providing illustrations of some embodiments of elements and features of the disclosed subject matter. Other embodiments of the disclosed subject matter, and of their elements and features, may be devised which do not depart from the spirit or scope of any of the claims. Features from different embodiments may be employed in combination. Accordingly, the scope of each claim is limited only by its plain language and the legal equivalents thereto.

What is claimed:

1. A brew device lacking a reservoir for water and comprising a housing and a support stowable within the housing.

2. The brew device of claim 1, further lacking a heater.

3. The brew device of claim 2, wherein the housing carries a pump, an injector, and at least one input/output device that controls operation of the pump.

4. The brew device of claim 3, wherein the pump withdraws hot water from an external source to the heating element.

5. The brew device of claim 1, wherein the support is deployable to support the housing in a raised position over a surface.

6. The brew device of claim 5, wherein the housing includes a receptacle for the support.

7. The brew device of claim 5, wherein the support includes a leg and a pair of feet coupled to the leg and movable between a stowed arrangement and a deployed arrangement.

8. The brew device of claim 7, wherein the pair of feet are positionable against and parallel to sides of the leg in the stowed arrangement and substantially at acute angles to the leg and at divergent angles from each other in the deployed arrangement.

9. The brew device of claim 8, wherein the pair of feet are pivotally coupled to the leg near an end of the leg.

10. The brew device of claim 7, wherein:
the leg comprises a button pin; and
a receptacle in the housing for stowing the support includes at least one hole that opens to an exterior of the housing and receives the button pin upon deploying the support to define a distance the riser extends from a bottom of the housing and secure the riser in an extended arrangement relative to the housing.

11. The brew device of claim 10, wherein the receptacle includes a plurality of holes that open to the exterior of the housing and receive the button pin to define a plurality of extended arrangements of the leg relative to the bottom of the housing.

12. The brew device of claim 1, wherein the housing has a height of about 7 inches or less and a width and a depth of about three inches or less.

13. A method of brewing a liquid, comprising:
deploying a support for a brew device, including placing the brew device in a deployed arrangement;
positioning the support on a surface, including positioning the brew device over the surface;
establishing flow communication between the housing to an external source of hot water;
placing a vessel on the surface and beneath a bottom of a housing of the brew device; and
actuating the brew device, including:
drawing the hot water from the external source into the housing;
injecting the hot water into a medium to be brewed; and
dispensing a brewed liquid from a holder carrying the medium into the vessel.

14. The method of claim 13, further comprising:
placing the medium in the holder, wherein injecting the hot water includes brewing the medium to form the brewed liquid.

15. The method of claim 14, wherein placing the medium in the holder comprises placing a medium for a brewed beverage in the holder.

16. The method of claim 14, wherein placing the medium in the holder comprises placing a dehydrated broth or stock in the holder.

17. The method of claim 13, wherein positioning the portable brew device above the surface includes:
deploying a support from the housing of the portable brew device, including positioning a leg of the support in an extended arrangement relative to the housing and locking the leg into the extended arrangement;
positioning feet coupled to the leg in a support arrangement in which the feet extend from the leg in divergent orientations, placing the support in a deployed arrangement; and
placing feet of the support on a surface, the leg of the support defining a distance the bottom of a housing of the dispenser is located above the surface.

18. The method of claim 13, further comprising:
adjusting a distance the bottom of the housing is located above the surface.

19. The method of claim 13, wherein deploying the support comprises deploying the support from the housing of the brew device.

20. The method of claim 13, further comprising:
collapsing the support, including placing the brew device in a stowed arrangement.
